(19) United States
(12) Patent Application Publication
(10) Pub. No.: US 2025/0203720 A1
(43) Pub. Date: Jun. 19, 2025

(54) 3D PRINTED HEATER SYSTEM

(71) Applicant: WATLOW ELECTRIC MANUFACTURING COMPANY, ST. LOUIS, MO (US)

(72) Inventors: Jacob LINDLEY, Nashville, TN (US); David REINWALD, St. Louis, MO (US); Brian BAKALA, Lake Geneva, WI (US)

(73) Assignee: WATLOW ELECTRIC MANUFACTURING COMPANY, ST. LOUIS, MO (US)

(21) Appl. No.: 19/066,909

(22) Filed: Feb. 28, 2025

Related U.S. Application Data
(63) Continuation of application No. PCT/US2023/073046, filed on Aug. 29, 2023.
(60) Provisional application No. 63/401,926, filed on Aug. 29, 2022.

(51) Int. Cl. H05B 3/18; B33Y 80/00; G01K 7/02; H05B 3/06

(52) U.S. Cl. CPC H05B 3/18; B33Y 80/00; G01K 7/02; H05B 3/06; H05B 2203/007; H05B 2203/016; H05B 2203/017; H05B 2203/019

(57) ABSTRACT

A tailored thermal body includes a substrate and a plurality of material regions extending throughout the substrate, the plurality of material regions having a variable thermal conductivity. At least one heating element is secured to the substrate. The substrate and the plurality of material regions are formed using at least one additive manufacturing process, and materials of the substrate and the plurality of material regions are chemically fused together.

### CROSS-REFERENCE TO RELATED APPLICATIONS

This application is a continuation of International Application No. PCT/US2023/073046, filed on Aug. 29, 2023, which claims priority to and the benefit of U.S. Provisional Patent Application No. 63/401,926, filed on Aug. 29, 2022. The disclosures of the above applications are incorporated herein by reference in their entireties.

### FIELD

The present disclosure relates to electrical heaters, and more particularly to electrical heaters manufacturing using additive manufacturing, or 3D printing processes.

### BACKGROUND

The statements in this section merely provide background information related to the present disclosure and may not constitute prior art.

Resistance heaters are used in a variety of industrial processes that require specific heating profiles and often within tight limits. Some typical resistance heaters include cartridge heaters, tubular heaters, and layered heaters, among other types of construction. Resistance heaters are integrated with a number of components such as terminal pads, power leads, temperature sensors, switches, insulation blankets, and housings/enclosures, among a number of others specific to a given application. Integration of the resistance heaters with these components in an overall thermal system can be costly, time consuming, and pose constraints on the design of the resistance heater.

For example, space is often limited and thus integration of terminal pads and power leads, especially for multiple resistance heaters or multiple zones within a resistance heater can limit the size or increase power requirements for a desired watt density or temperature distribution. Further, thermal losses through these various components can be significant, again requiring higher power requirements and a less efficient heater system.

These issues related to the design and integration of resistance heaters, among challenges with resistance heaters, are addressed by the present disclosure.

### SUMMARY

This section provides a general summary of the disclosure and is not a comprehensive disclosure of its full scope or all of its features.

The present disclosure provides a tailored thermal body comprising a substrate, a plurality of material regions extending throughout the substrate, the plurality of material regions having a variable thermal conductivity, and at least one heating element secured to the substrate. The substrate and the plurality of material regions are formed using at least one additive manufacturing process, and materials of the substrate and the plurality of material regions are chemically fused together.

In variations of this form, which may be implemented individually or in any combination: the plurality of material regions comprise a single material having a variable density; the plurality of material regions comprise a plurality of different materials; the at least one heating element is formed using an additive manufacturing process and is chemically fused to the substrate; the at least one heating element defines at least one of a variable width and a variable thickness; the at least one heating element comprises a material having sufficient temperature coefficient of resistance (TCR) to function as a heater and a temperature sensor; the material of the heating element defines variable properties and has the TCR present only in predefined areas of the heating element; the at least one heating element comprises a negative temperature coefficient of resistance (NTC) material; the at least one heating element comprises a variable material composition extending along at least one of a length and thickness; at least two heating elements are formed from different materials and defining a junction electrically connecting the two heating elements; a coating is disposed over at least a portion of an exterior of the substrate, the coating formed using an additive manufacturing process and being chemically fused with the substrate; the thermal conductivity of the plurality of material regions is lower than the thermal conductivity of the substrate; the plurality of material regions form at least one pocket having a base and peripheral walls extending upwardly from the pocket, wherein the at least one heating element is disposed on an upper surface of the pocket; at least one heat spreader extends across the pocket and between the peripheral walls, the at least one heat spreader formed using an additive manufacturing process and being chemically fused within the substrate; a plurality of heat spreaders extend across the pocket and between the peripheral walls, thereby forming at least one internal cavity; a plurality of pockets are separated by dividing walls and a corresponding plurality of heating elements disposed in each of the plurality of pockets; at least one heat spreader extends across the plurality of pockets and between the peripheral walls and the dividing walls, the at least one heat spreader formed using an additive manufacturing process and being chemically fused within the substrate; the substrate comprises a material having variable density; the variable density extends along one or a combination of Cartesian coordinate directions within the substrate; a heat sink is disposed adjacent to an exterior surface of the substrate, wherein the heat sink is formed using an additive manufacturing process and is chemically fused to the substrate; electrical terminals are in contact with the at least one heater, the electrical terminals formed using an additive manufacturing process and being chemically fused to the substrate; a plurality of heating elements and electrical busses are in contact with the plurality of heating elements, the electrical busses formed using an additive manufacturing process and being chemically fused to the substrate; at least one sensor is disposed within the substrate; at least one sensor is formed using an additive manufacturing process and is chemically fused to the substrate; at least one sensor is a thermocouple having a junction, thermocouple formed using an additive manufacturing process and being chemically fused to the substrate; the substrate comprises a plurality of apertures configured to accommodate at least one of electrical connections to the at least one heating element and mechanical attachments; electrical circuitry is disposed within the substrate and in electrical communication with the at least one heating element, the electrical circuitry formed using an additive manufacturing process and being chemically fused to the substrate; the plurality of material regions are configured based on a computer generated model; the plurality of material regions comprise a continuously variable thermal conductivity; and the heating element is completely embedded within substrate.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side cross-sectional view of tailored thermal body with a heating element constructed according to the teachings of the present disclosure;

FIG. 2 is a side cross-sectional view of another form of a tailored thermal body with a heating element and lateral heat spreading layers constructed according to the teachings of the present disclosure;

FIG. 3 is a side cross-sectional view of yet another form of a tailored thermal body with heating elements in multiple zones and constructed according to the teachings of the present disclosure;

FIG. 4 is a side cross-sectional view of another form of a tailored thermal body with heating elements in multiple zones and a heat spreader constructed according to the teachings of the present disclosure;

FIG. 5 is a side cross-sectional view of still another form of a tailored thermal body with a heating element and various fill densities constructed according to the teachings of the present disclosure; and

FIG. 6 is a side cross-sectional view of another form of a tailored thermal body with heating elements in multiple zones, along with internal bussing and electrical terminals constructed according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The teachings herein are directed to a variety of innovative tailored thermal bodies having a heating element, or heating elements, that are manufactured with at least one additive manufacturing (AM) process. The AM processes include, by way of example, stereolithography, material jetting, binder jetting, material extrusion, powder bed fusion, sheet lamination, and directed energy deposition, among others. As set forth in greater detail below, one or more of these AM processes are used to manufacture a variety of tailored thermal bodies having characteristics previously unachievable with conventional heater construction technologies. The tailored thermal bodies may be employed in a variety of applications, and more specifically industrial processes such as chemical process heating, battery electric vehicle (BEV) heating, circulation heaters for powerplants, and exhaust emissions heating, among others.

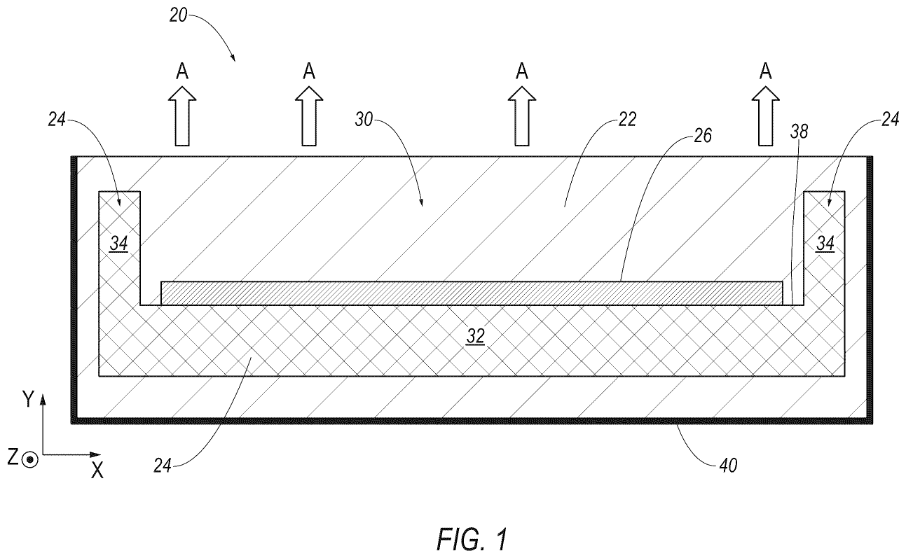

With reference to FIG. 1, one form of a tailored thermal body is illustrated and generally indicated by reference numeral 20. The tailored thermal body includes a substrate 22 and a plurality of material regions 24 extending throughout the substrate 20, the plurality of material regions having a variable thermal conductivity. At least one heating element 26 is secured to the substrate 22 as shown. The substrate 22 and the plurality of material regions 24 are formed using at least one AM process, and materials of the substrate 22 and the plurality of material regions 24 are chemically fused together. As used herein, the phrase “chemically fused together” should be construed to mean that the materials of each respective component (e.g., substrate 22 and material regions 24) form chemical bonds with each other and are joined together chemically and mechanically into a unitized component that is inseparable in the absence of extreme heat above their individual glass transition/melting temperatures or a solvent.

Generally, the material regions 24 are designed to tailor heat transfer from the heating element 26 to a target, which may be the substrate 22 itself, or another component(s) within or outside the bounds of the substrate 22. One example application is a semiconductor processing chamber, where the substrate 22 is a pedestal and the target is a silicon wafer on the pedestal. It should be understood that the applications for the teachings of the present disclosure are numerous and thus the example semiconductor processing chamber should not be construed as limiting the scope of the present disclosure.

In this example shown, the plurality of material regions 24 form at least one pocket 30 having a base 32 and peripheral walls 34 extending upwardly from the pocket 30. Further, the heating element 26 is disposed on an upper surface 38 of the pocket 30 as shown, although the heating element 26 could be disposed at any location, and in any orientation within the pocket 30 while remaining within the scope of the present disclosure. With the base 32 and peripheral walls 34 formed by the material regions 24, the heat generated by the heating element 26 is directed upwards in the direction of arrows “A” and within the pocket 30.

In one form, the plurality of material regions 24 comprise a single material having a variable density. The variable density is generally achieved by adjusting settings of the AM process, such as laser power in a laser powder sintering process. Other examples include nozzle speed, nozzle feed rate, fill pattern (i.e. some regions having a higher/lower fill density than others), laser frequency, laser rastoring speed, and post processing, among others. In another form to achieve the variable density, the plurality of material regions 24 comprise a plurality of different materials. In still another form, the thermal conductivity of the plurality of material regions 24 is lower than the thermal conductivity of the substrate 22. In still another form, the plurality of material regions 24 have a continuously variable thermal conductivity throughout the substrate 22.

The heating element 26 in one form is also formed using an AM process and is chemically fused to the substrate 22. In another form, the heating element 26 is a discrete element that has been pre-manufactured, such as by way of example a resistive wire, which is placed within the substrate 22 and material regions 24 during the AM build process. In another variation in which there are a plurality of heating elements 26, some or all of the heating elements 26 are be formed using an AM process, and some or all of the heating elements 26 are discrete elements that are pre-manufactured. Further, the heating elements 26 may be of any construction, including by way of example layered heaters, tubular heaters, cartridge heaters, foil heaters, and combinations thereof, among others.

The heating element 26 may also define a variable width and/or a variable thickness. In another form, the heating element 26 comprises a variable material composition extending along at least one of a length and thickness. Such heating element constructions are illustrated and described in U.S. Pat. No. 7,132,628 titled “Variable Watt Density Layered Heater” and its family of patents, which are commonly owned with the present application and the contents of which are incorporated herein by reference in their entirety. Similarly, the substrate 22 in one form comprises a material having variable density, and the variable density extends along one or a combination of Cartesian coordinate directions (X, Y, Z) within the substrate 22.

The heating element 26 may also include a variety of materials and configurations for the particular application. For example, in one form, the heating element 26 comprises a material having sufficient temperature coefficient of resistance (TCR) to function as a heater and a temperature sensor. This construction is often referred to as “two-wire” since only two wires are needed rather than four, two for the heating element 26 and two for a discrete temperature sensor. In a variation of this “two-wire” form, the material of the heating element 26 defines variable properties and has the sufficient TCR present only in predefined areas of the heating element. In this form, additional signal wires/traces may be secured at discrete locations along the length of the heating element 26 that has variable properties. The signal wires/traces in one variation of the present disclosure are also formed using an AM process, along with other features of the tailored thermal body 20 . . . . In still another variation of this form, at least two heating elements 26 are formed from different materials and define a junction electrically connecting the two heating elements 26. This junction is used to determine temperature at the junction, similar to the operation of a standard thermocouple.

In still another form, the heating element 26 comprises a negative temperature coefficient of resistance (NTC) material. In this application, known resistance values of the heating element 26 actually decreasing with increased temperature can be combined with other features of the application to tailor an amount of heat being provided. An example of such configurations are illustrated and described in U.S. Pat. No. 8,536,496 titled “Adaptable Layered Heater System,” which is commonly owned with the present application and the contents of which are incorporated herein by reference in their entirety.

While the heating element 26 is shown as being completely embedded within substrate 22, it should be understood that one or more heating elements 26 may be located on an exterior surface of the substrate or be at least partially disposed within the substrate 22. These and other configurations/locations of the heating element(s) 26 should be construed as falling within the scope of the present disclosure.

As further shown, an optional coating 40 is disposed over at least a portion of an exterior of the substrate 22. The coating 40 is similarly formed using an AM process and is chemically fused with the substrate 22. The coating 40 may be any of a variety of materials for a specific function. For example, in one form, the coating 40 is a refractive coating used in applications in which thermal energy is directed away from the tailored thermal body 20. In one variation, the coating 40 includes surface texturing to increase thermal emissivity. In another variation, the coating 40 defines a smooth surface to reduce thermal radiation. Further, different materials for the coating 40 may be employed for chemical compatibility and/or for fluid dynamics, namely, influencing a flow of fluid along the exterior of the substrate 22.

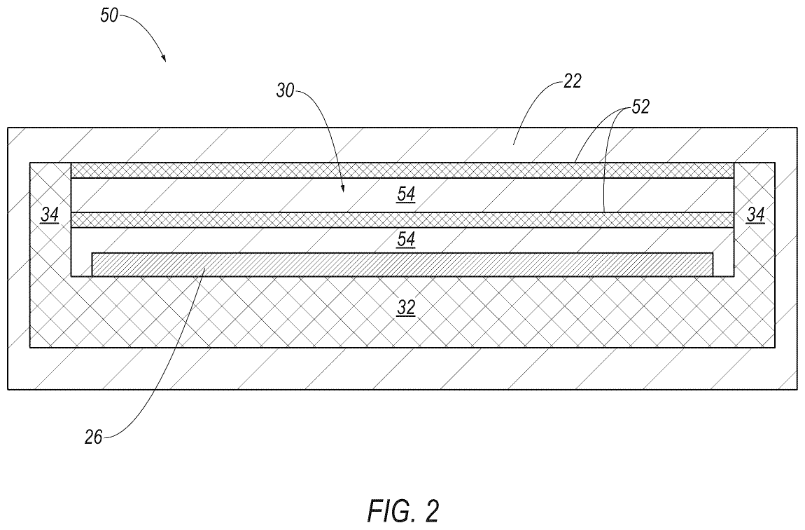

Referring now to FIG. 2, another form of a tailored thermal body is illustrated and indicated by reference numeral 50. The tailored thermal body 50 comprises at least one heat spreader 52 (and in this example, two heat spreaders 52) extending across the pocket 30 and between the peripheral walls 34. The heat spreaders 52 are similarly formed using an AM process and re chemically fused within the substrate 22. In this form with a plurality of heat spreaders 52, internal cavities 54 are formed within the pocket 30 as shown. The heat spreaders 52 generally function to distribute the heat generated by the heating element 26 and could be arranged in any orientation and size while remaining within the scope of the present disclosure.

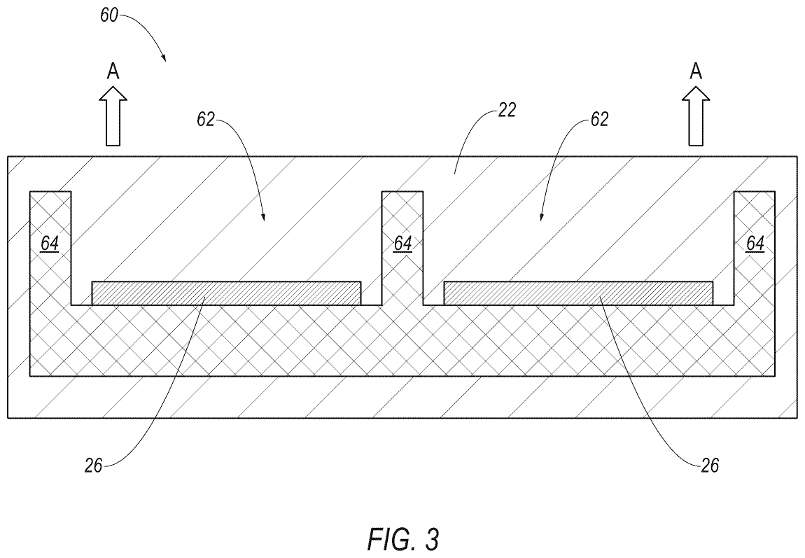

Referring to FIG. 3, another form of a tailored thermal body is illustrated and indicated by reference numeral 60. The substrate 22 in this form includes a plurality of pockets 62 separated by dividing walls 64 and a corresponding plurality of heating elements 26 disposed in each of the plurality of pockets 62. Accordingly, the individual heating elements 26 provide heat locally to areas in the direction of arrows “A” in this particular application.

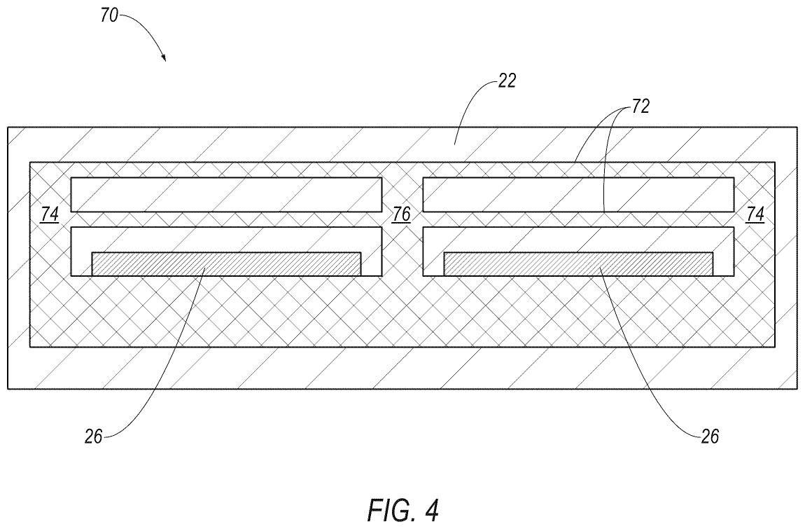

Now referring to FIG. 4, yet another form of a tailored thermal body (a variation of FIG. 3) is illustrated and indicated by reference numeral 70. In this form, at least one heat spreader 72 (two in this example) extends across the plurality of pockets and between the peripheral walls 74 and the dividing walls 76. The heat spreaders 72 are formed using an AM process and are chemically fused within the substrate 22.

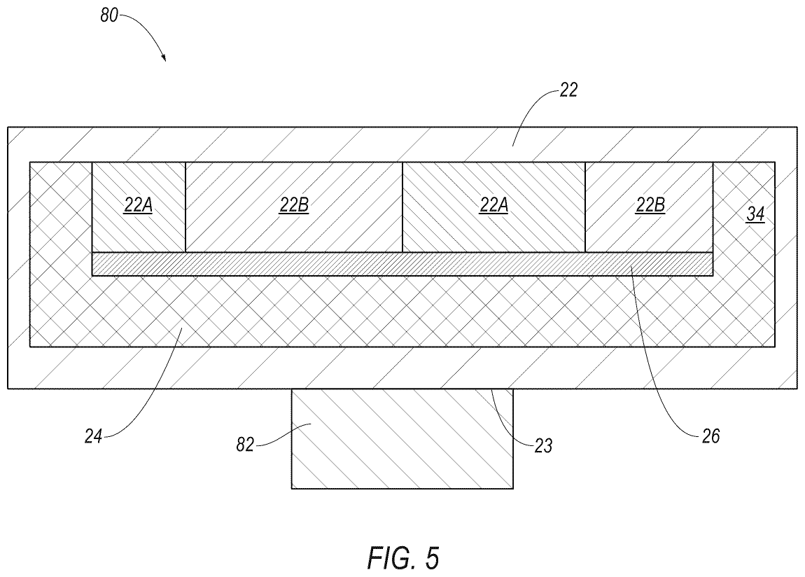

Turning now to FIG. 5, a tailored thermal body 80 comprises a heat sink 82 disposed adjacent to an exterior surface 23 of the substrate 22. The heat sink 82 is formed using an AM process and is chemically fused to the substrate 22. The heat sink 82 generally functions to draw excess heat directionally away from the heating element 26. In this form as shown, the variable composition/density of the substrate 22 is illustrated with the different zones of material 22A and 22B. Such a variable composition/density can also be used to tailor heat transfer from the heating element 26 depending on application requirements.

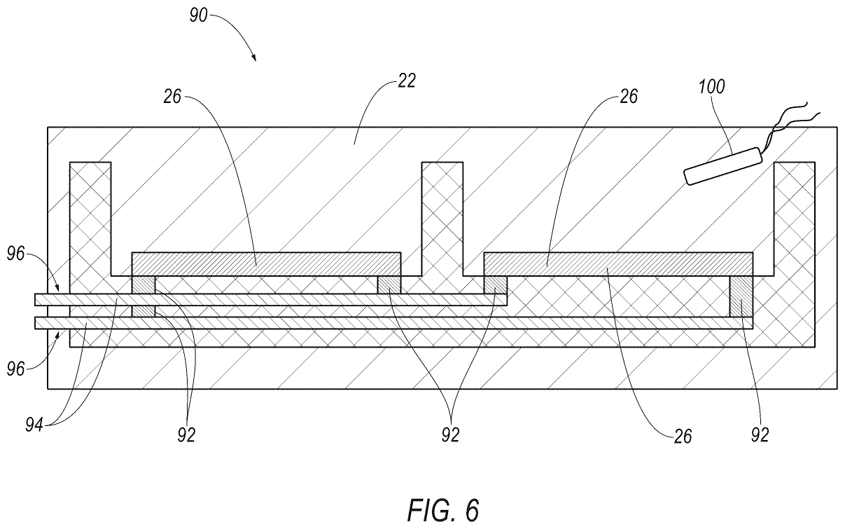

Referring to FIG. 6, another form of a tailored thermal body 90 comprises electrical terminals 92 in contact with the heating elements 26. Similarly, the electrical terminals 92 are formed using an AM process and are chemically fused to the substrate 22. As further shown, when multiple heating elements 26 are employed, optional electrical busses 94 are in contact with the heating elements 26. The electrical busses 94 are formed using an AM process and are chemically fused to the substrate 22. The substrate 22 further includes apertures 96 configured to accommodate the electrical connections (e.g., electrical busses 94) to the heating element 26. Further, additional apertures may be provided for various and mechanical attachments to the substrate, such as by way of example handles, hinges, and fasteners (not shown), among others.

The tailored thermal body 90 may also include a sensor 100 disposed within the substrate 22. The sensor 100 is a temperature sensor in one form but may also include other types of sensors such as by way of example, pressure sensors and strain sensors, among others. The sensor 100 is also formed using an AM process and is chemically fused to the substrate 22. In one form, the sensor 100 is a thermocouple having a junction (not shown), and the junction is also formed using an AM process and is chemically fused to the substrate 22.

It should be understood that the various forms of the present disclosure illustrated and described herein may be implemented in any combination while remaining within the scope herein. For example, the sensor 100 may be implemented with any of the tailored thermal bodies and their variations of substrates, material regions, heating elements, heat sinks, terminations, and electrical busses, among others.

In another form, the various tailored thermal bodies may also include electrical circuitry (not shown) disposed within the substrate 22 and in electrical communication with the heating element(s) 26. The electrical circuitry is also formed using an AM process and is chemically fused to the substrate 22.

In another variation of the present disclosure, material regions 24 are configured based on a computer generated model. By “configured,” this should be construed to mean both materials, material properties, and geometry.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A tailored thermal body comprising:
a substrate;
a plurality of material regions extending throughout the substrate, the plurality of material regions having a variable thermal conductivity; and
at least one heating element secured to the substrate;
wherein the substrate and the plurality of material regions are formed using at least one additive manufacturing process, and materials of the substrate and the plurality of material regions are chemically fused together.

2. The tailored thermal body according to claim 1, wherein the plurality of material regions comprise a single material having a variable density.

3. The tailored thermal body according to claim 1, wherein the plurality of material regions comprise a plurality of different materials.

4. The tailored thermal body according to claim 1, wherein the at least one heating element is formed using an additive manufacturing process and is chemically fused to the substrate.

5. The tailored thermal body according to claim 4, wherein the at least one heating element defines at least one of a variable width and a variable thickness.

6. The tailored thermal body according to claim 4, wherein the at least one heating element comprises a material having sufficient temperature coefficient of resistance (TCR) to function as a heater and a temperature sensor.

7. The tailored thermal body according to claim 6, wherein the material of the heating element defines variable properties and has the TCR present only in predefined areas of the heating element.

8. The tailored thermal body according to claim 4, wherein the at least one heating element comprises a negative temperature coefficient of resistance (NTC) material.

9. The tailored thermal body according to claim 4, wherein the at least one heating element comprises a variable material composition extending along at least one of a length and thickness.

10. The tailored thermal body according to claim 4, further comprising at least two heating elements formed from different materials and defining a junction electrically connecting the two heating elements.

11. The tailored thermal body according to claim 1 further comprising a coating disposed over at least a portion of an exterior of the substrate, the coating formed using an additive manufacturing process and being chemically fused with the substrate.

12. The tailored thermal body according to claim 1, wherein the thermal conductivity of the plurality of material regions is lower than the thermal conductivity of the substrate.

13. The tailored thermal body according to claim 1, wherein the plurality of material regions form at least one pocket having a base and peripheral walls extending upwardly from the pocket, wherein the at least one heating element is disposed on an upper surface of the pocket.

14. The tailored thermal body according to claim 13, further comprising at least one heat spreader extending across the pocket and between the peripheral walls, the at least one heat spreader formed using an additive manufacturing process and being chemically fused within the substrate.

15. The tailored thermal body according to claim 13, further comprising a plurality of heat spreaders extending across the pocket and between the peripheral walls, thereby forming at least one internal cavity.

16. The tailored thermal body according to claim 13, further comprising a plurality of pockets separated by dividing walls and a corresponding plurality of heating elements disposed in each of the plurality of pockets.

17. The tailored thermal body according to claim 1, further comprising a heat sink disposed adjacent to an exterior surface of the substrate, wherein the heat sink is formed using an additive manufacturing process and is chemically fused to the substrate.

18. The tailored thermal body according to claim 1, further comprising electrical terminals in contact with the at least one heating element, the electrical terminals formed using an additive manufacturing process and being chemically fused to the substrate.

19. The tailored thermal body according to claim 1, further comprising a plurality of heating elements and electrical busses in contact with the plurality of heating elements, the electrical busses formed using an additive manufacturing process and being chemically fused to the substrate.

20. The tailored thermal body according to claim 1, further comprising at least one sensor disposed within the substrate.

21. The tailored thermal body according to claim 20, wherein the at least one sensor is formed using an additive manufacturing process and is chemically fused to the substrate.

22. The tailored thermal body according to claim 21, wherein the at least one sensor is a thermocouple having a junction, thermocouple formed using an additive manufacturing process and being chemically fused to the substrate.

23. The tailored thermal body according to claim 1, further comprising electrical circuitry disposed within the substrate and in electrical communication with the at least one heating element, the electrical circuitry formed using an additive manufacturing process and being chemically fused to the substrate.
